(19) United States
(12) Patent Application Publication
(10) Pub. No.: US 2020/0119499 A1
(43) Pub. Date: Apr. 16, 2020

(54) EXPLOSION-PROOF ELECTRICAL CONNECTOR

(71) Applicant: R. Stahl Schaltgeräte GmbH, Waldenburg (DE)

(72) Inventors: Manfred Leischner, Öhringen (DE); Albrecht Hopf, Schnaitsee (DE)

(73) Assignee: R. Stahl Schaltgeräte GmbH, Waldenburg (DE)

(21) Appl. No.: 16/617,638

(22) PCT Filed: May 24, 2018
(86) PCT No.: PCT/EP2018/063600

§ 371 Date: Nov. 27, 2019

(30) Foreign Application Priority Data
Jun. 1, 2017 (DE) 10 2017 112 160.9

(51) Int. Cl. H01R 13/703; H01R 13/527; H01R 13/625

(52) U.S. Cl. CPC H01R 13/7036; H01R 13/625; H01R 13/527

(57) ABSTRACT

A plug-in device which has a blocking sleeve, which divides the plug-in operation between the plug and the socket into two path sections. In a first path section, before the electrical contact is established, explosion-proof encapsulation of the plug and the socket is brought about. The plug and the socket are initially temporarily locked in this position and further insertion is blocked. Further insertion is not enabled until the sleeve is rotated relative to the socket housing and the plug housing. Once this has occurred, the second path section can be run through, in which the electrical contact is established. Thereafter, by further rotation of the blocking sleeve, the plug and the socket are locked in the coupled state by means of the blocking gate, which blocking gate is effective between the blocking sleeve and the socket housing and between the blocking sleeve and the plug housing

The subject matter of the invention relates to an explosion-proof connector, in particular a connector of protection class Ex-d.

Connectors consistent with protection class Ex-d are frequently used in explosive areas. In doing so, the formation of an ignition source for flammable gasses or vapors in the environment must be precluded, in particular while connectors are being connected or disconnected.

Regarding this, an explosion-proof connector comprising a plug part and a socket part has been known from publication DE 20 2005 010 927 U1, wherein contact sockets are arranged recessed in the channels of an insulating body. The plug housing has a receptacle for receiving the socket housing. Together with the insertion channels, the plug pins also form a tight slit like the plug housing with the socket housing. The plug housing has a thread on the outside that is associated with a union nut on the socket housing. This union nut ensures a firm connection between the plug part and the socket part, so that they cannot be inadvertently pulled apart. Furthermore, the screw attachment can form a bayonet fitting with the socket housing. In a first turning position of the bayonet fitting, the plug housing can be moved relative to the socket housing out of the connecting position into a retaining position, and then, only after one additional turn of the bayonet fitting, the plug housing can be released completely.

It should be noted that electrical contacts can form sources of ignition not only during the opening process but also during the closing process.

Accordingly, it is the object of the invention to provide a connector arrangement, which displays improved safety during the connecting process and during the disconnecting process as well. This object is achieved with the connector arrangement according to claim 1.

The connector arrangement according to the invention comprises a blocking gate arrangement effective between the plug housing and the socket housing, which blocking gate arrangement is adapted to enable—in a first turning position—a first section of the insertion path of the connector housing, in which there is no contact yet between the plug contact and an associate contact socket. During the rotation of the blocking gate arrangement required for the continued clearance of the insertion path, the second section of the insertion path is cleared, however, before that, the first insertion path is blocked against pull-out. Consequently, a retaining position is defined, in which the socket housing and the plug housing are locked relative to each other. From the first section of the insertion path the user will arrive at the second section of the insertion path by rotating the sleeve, in which case the plug housing and the socket housing are locked axially relative to each other during the rotation. Consequently, there is always a forced stop between the two path sections during the plug-in operation, as well as during the separating operation, which stop cannot be skipped or outsmarted. Preferably, this is achieved in that a guide groove of a blocking gate formed by the sleeve and the plug housing or the socket housing is divided into a first axial section and a second axial section, which are connected to each other by an interposed circumferential section. At the beginning and at the end of the circumferential section, respectively, there are corners (preferably right-angled corners) against which a sliding block abuts during its straight axial movement or its circumferential movement, respectively, without being redirected in lateral direction. As a result of this, the movement of the blocking gate stops at the corners of the gate, which causes the aforementioned forced stop of the movement.

The connector arrangement according to the invention is easy to handle, while all explosion protection requirements are met. In particular, no twisting of the plug relative to the plug housing whatsoever is necessary. Locking and unlocking is accomplished only by turning the sleeve. Furthermore, it is possible, in a simple manner, to produce a protective conductor connection which, while the connection is being established, closes before all other contacts and opens after disconnecting all other contacts. This requires neither sliding contacts nor other special measures, but only an appropriate positioning of the plug contact pins and the contact sockets relative to each other. For example, the protective contact plug pin may be longer than all the other contact pins, and/or the associate protective contact socket may be closer to the housing front surface than all other sockets.

In particular, the invention ensures that sufficient time elapses between the separation of the electrical contacts and the unlocking, in order to allow a potentially ignited explosion in the connector arrangement to decay. The necessary decay time is maintained at all times because, after separating the contacts, the sleeve must first be turned manually in order to unlock the socket housing and the plug housing from each other.

Preferably, the plug contact and the plug channel, whose diameter is adapted to the plug contact, form a flame-arresting gap, before the plug contact comes into contact with the associated socket contact located in the plug channel.

Alternatively or additionally, the sleeve and the plug housing, and/or the plug housing and the socket housing, and/or the sleeve and the socket housing at the end of the first section of the insertion path form a flame-arresting gap—i.e., before one of the plug contacts comes into contact with the respectively associate socket contact. This ensures that an explosion ignited in the connector arrangement cannot leave the connector arrangement, i.e., cannot result in a flash fire toward the outside.

In a preferred embodiment, the blocking groove comprises two axial sections which are offset relative to each other in circumferential direction, as well as an interposed circumferential section extending in circumferential direction. Furthermore, an additional section extending in circumferential direction may adjoin the second axial section, in which additional section the plug housing and the socket housing are locked relative to each other. Preferably, there are hardly any corners or unrounded corners formed between the sections.

In addition to additional details of various embodiments of the invention, it is particularly advantageous when the blocking gate arrangement is associated with a detent arrangement which comprises detent points—in particular on the ends of the first section of the insertion path and the second section of the insertion path, said ends being at a distance from each other due to a circumferential rotation of the sleeve. Furthermore, at the point of the insertion path, at which the plug housing and the socket housing are completely joined, there is provided a detent position. It is necessary to overcome the detent point in order to be able to pull the plug housing and the socket housing apart. As a result of this, a gradual, reluctant separation of the plug contact from the contact socket is not possible. Rather, the required overcoming of the detent position effects a clear and rapid pulling of the plug out of the contact position into the—preferably locked again—intermediate position.

The drawings illustrate exemplary embodiments of the invention. They show in

FIG. 1 a simplified, perspective, partially cut open representation of a connector arrangement,

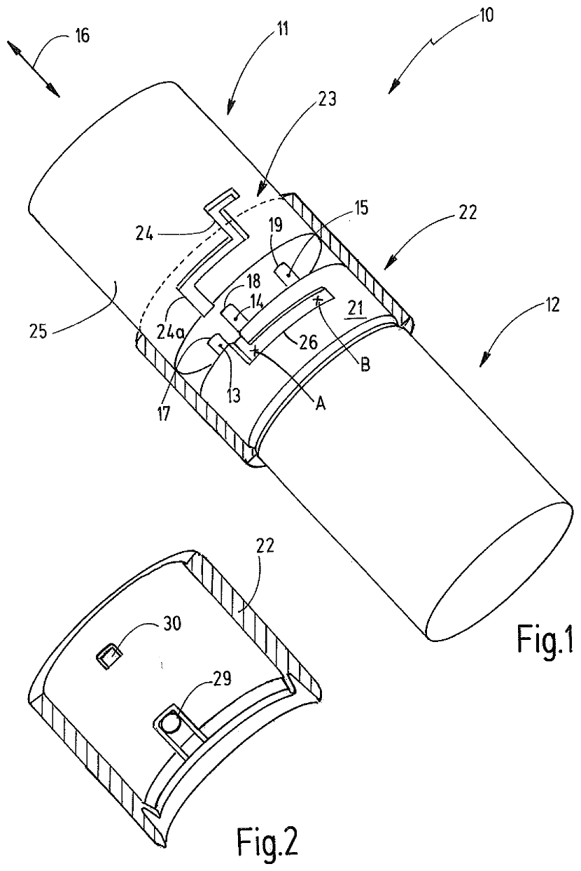

FIG. 2 a cut open, perspective representation of the blocking sleeve of the connector arrangement as in FIG. 1,

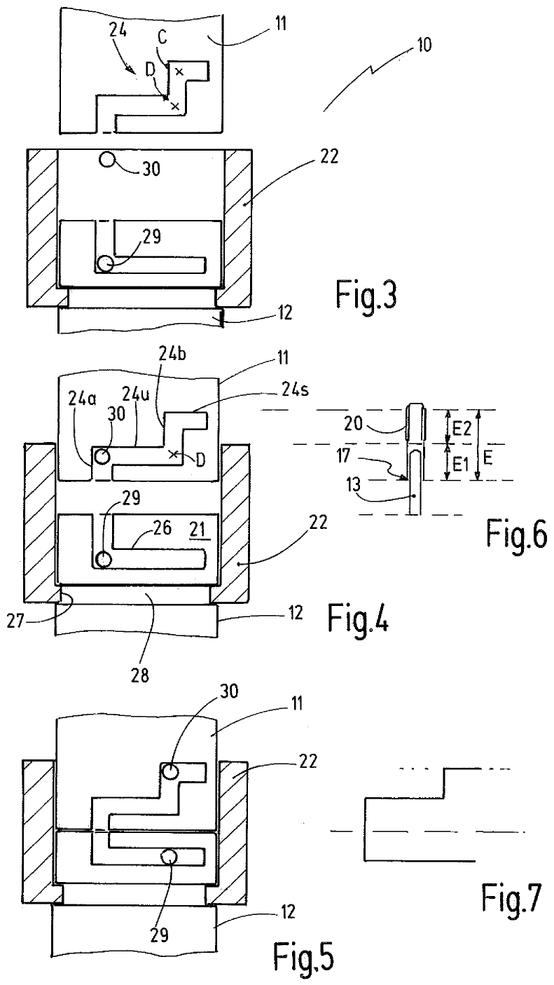

FIGS. 3 to 5 a schematized detail of a side elevation, of the connector arrangement as in FIG. 1, in various stages of connection,

FIG. 6 a sketch to illustrate dimensional relationships of the connector arrangement as in FIG. 4,

FIG. 7 a schematic representation according to FIG. 5 of the blocking gate of the connector arrangement according to the invention,

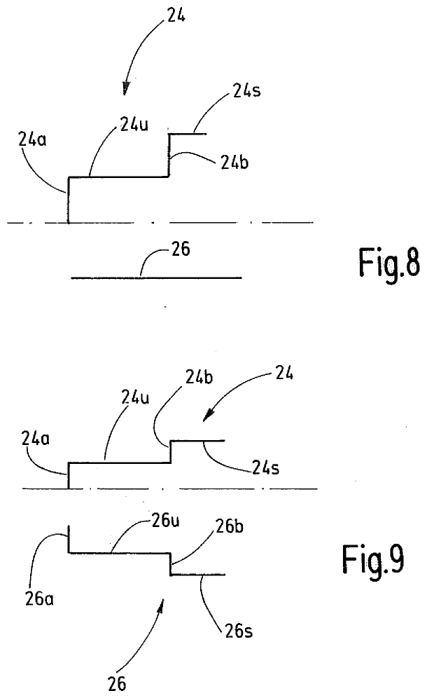

FIGS. 8 and 9 diagrammatic representations of additional schematized blocking groove courses.

FIG. 1 shows a schematic connector arrangement 10. The connector arrangement 10 comprises a socket housing 11 and a plug housing 12 which bears one, preferably several plug contacts 13, 14, 15. The plug contacts 13 to 15 extend parallel to each other in axial direction. The axial direction coincides with the joining direction (Arrow 16), in which the socket housing 11 and the plug housing 12 are joined and moved apart.

Provided in the socket housing 11 are openings 17 to 19 belonging to the plug channels which are associated with the plug contacts 13 to 15. Socket contacts are arranged in these openings, which socket contacts are illustrated by FIG. 6 with reference to a plug channel having the opening 17 and a socket contact 20.

The plug housing 12 has a cylindrical surface 21 which is oriented concentrically with respect to the insertion direction. A blocking sleeve 22 is held on the cylindrical surface 21, which sleeve can be rotated about the axial direction (arrow 16)—at least in a restricted manner. The axial direction coincides with the direction of the insertion movement and the release movement. FIG. 1 is a longitudinal cut-open representation of the blocking sleeve 22 to provide a view on the plug contacts 13 to 15, as well as on the blocking gate arrangement 23. The latter comprises a blocking groove 24 that is provided in a cylindrical section 25 of the socket housing 11 which adjoins the front surface of the socket housing 12. The cylindrical section 25 is oriented so as to be concentric with the axial direction.

Another blocking groove 26 may be provided in the cylindrical section 21 of the plug housing 12, in which case said section extends over the blocking sleeve 22. Both blocking grooves 24, 26 are accordingly arranged in one section of the socket housing 11 or the socket housing 12, respectively, in which case the blocking sleeve 22 extends over said section when the socket housing 11 and the plug housing 12 are completely joined.

The blocking groove 24 has a first section 24a extending in axial direction, which section corresponds to a first section of the insertion path E1 (FIG. 6). In this path section E1 the contact pin 13 enters the plug channel, without reaching the socket contact 20. A groove section 24u adjoins the groove section 24a, which section 24u preferably extends in circumferential direction. This is adjoined by another groove section 24b extending again in axial direction, which section 24b marks the second section E2 of the insertion path E (FIG. 6). Adjoining the end of the second groove section 24b there may be a groove section 24s extending in circumferential direction, which section 24s is adapted for locking and blocking any axial movement of the plug housing 12 relative to the socket housing 11. Therefore, the groove 24 has three right-angled bends, namely two right bends and one left bend in between.

The groove 26 provided in the plug housing 12 extends in circumferential direction and thus parallel to the groove section 24. Furthermore, the blocking sleeve 22 may be rotatably held in axially firm manner by means of an annular rib 27 or by other inward-pointing projections in a bearing groove 28 of the plug housing 12. However, it is also possible to place the sleeve—with axial clearance—on the plug housing 12.

As is obvious from FIG. 2, the blocking sleeve 22 has, on its inner surface, an inward-directed cam 29 which is associated with the blocking groove 26 and comes into engagement with said groove. Furthermore, the blocking sleeve 22 comprises a second cam 30 which is associated with the blocking groove 24 and comes into engagement therewith, as soon as the plug housing 12 and the socket housing 11 are joined together. Whereas the cam 30 may be configured as a rigid cam, the cam 29 may be configured as a radially resilient latch cam. The latter may be associated with a detent recess A, B marked with an “x” to clearly signal to the user the position of the blocking sleeve 22 relative to the plug housing 12. Optionally, the cam 30 may be configured—additionally or alternatively—as a radially resilient cam which is associated with detent recesses at the desired points of the blocking groove 24. Such detent recesses may be provided, for example, at the points C and D marked with an “x” in FIG. 3.

The connector arrangement 10 described so far works as follows:

Initially, the blocking sleeve 22 is rotated into its detent position A in order to join the plug housing 12 and the socket housing 11. In doing so, the cam 30 is in the first groove section 24a, as a result of which all plug contacts 13, 14, 14 can be inserted into the appropriate plug channels. However, they do not reach their associated socket contacts. By rotating the blocking sleeve, the cams 29, 30 now move in the grooves depicted by FIG. 4, namely the groove sections 24u and the blocking groove 26 until the cam 30 arrives at the end of the groove section 24u. In doing so, said cam reaches the beginning of the second groove section 24b so that it is possible to move the plug and the socket further toward each other. FIG. 6 shows that now—together with the plug contact 17—the second section E2 of the insertion path E is being passed, as a result of which the electrical contact between the contact pin 13 and the socket contact 20 is established. A further rotation of the blocking sleeve is now possible, while the cam 30 moves through the groove section 24s and the cam 29 reaches the right end of the blocking groove 26 in FIG. 4. The plug and the socket are now coupled and locked to each other.

The separation of plug and socket takes place in reverse direction. Moving out of the just described position, the blocking sleeve 22 is turned in opposite direction, as a result of which the cams 29, 30 arrive in the position depicted by FIG. 5. Now it is possible to pull the plug housing 12 and the socket housing 11 away from each other, as a result of which all contacts are electrically separated from each other. A potentially occurring ignition of gas that has penetrated remains restricted to the plug channels and/or the intermediate space between the front surfaces of the plug housing 12 and the socket housing 11. For example, the blocking sleeve 22 which abuts relatively tightly against the plug housing 12 and the socket housing 11 prevents the exit of flames or burning particles consistent with the ignition protection class (pressure-resistant encapsulation (ex-d). Alternatively, other structures of the plug housing 12 and the socket housing 11 that are not shown by FIG. 1 may form a flame-arresting gap.

Further turning of the sleeve 22 moves the arrangement in the state as in FIG. 4, according to which the plug and the socket can be completely separated from each other, as shown by FIG. 3.

Considering the embodiment described hereinabove, the blocking groove 26 has a short section which extends in axial direction. Optionally, this may also be omitted, as is schematically indicated in FIG. 8.

Furthermore, it is possible according to FIG. 9 to configure not only the blocking groove 24, but additionally, also the blocking groove 26 in axial direction—appropriately mirrored stepped. This blocking groove 26 is then divided into appropriate axial sections 26a, 26b, as well as circumferential sections 26u, 26s.

Furthermore, it is possible to provide the blocking groove 24 only in circumferential direction, whereas the blocking groove 26 is stepped in axial direction. In this case, as already in the embodiment of FIG. 6, an axial mobility of the blocking sleeve 22 on the plug housing 12 must be possible.

In modification of the embodiment described hereinabove, wherein the blocking sleeve 22 is associated with the plug housing 12 and held thereon, the blocking sleeve 22 may also alternatively be held on the socket housing 11 in a captive, axially immovable or also axially movable manner. Further alternatively, the blocking sleeve 22 may be configured so as to be detachable from the socket housing 11, as well as from the plug housing 12. In this case, the blocking groove 24, as well as the blocking groove 26, are open on the respective front sides of the socket housing 11 and the plug housing 12.

In all the embodiments described hereinabove it was assumed that the blocking grooves 24, 26 are provided in the housings 11, 12, while the cams 29, 30 are arranged on the inside cylindrical circumferential surface of the blocking sleeve 22. However, it is also possible to provide the blocking grooves 24, 26 on the inside surface of the blocking sleeve 22, while the cams 29, 30 are configured as radially out-ward extending projections on the socket housing 11 and the plug housing 12. Furthermore, it is pointed out that the cams 29, 30 may also be arranged offset with respect to each other by an angle in circumferential direction. An axial alignment is not necessarily required. In an offset cam arrangement, the corresponding blocking grooves 24, 26 are also offset in circumferential direction.

Furthermore, it is pointed out that for improved identification of the current plugging state, a mark may be applied to the blocking sleeve 22, which mark is associated with a mark on the plug housing 12 and/or on the socket housing 11. The marks may be projections, recesses, apertures or the like that are provided on the blocking sleeve 22, for example. The associate marking associated with the respective housing may be a color code, a symbol, a projection or a recess or the like. Alternatively, the marking may be applied to the plug housing 11 and/or the socket housing 11. Such a marking may be associated with a corresponding structure on the blocking sleeve 22.

An inventive connector device comprises a blocking sleeve, which divides the insertion operation between the plug and the socket into two path sections. In a first path section, before the electrical contact is established, explosion-proof encapsulation of the plug and the socket is brought about. The plug and the socket are initially temporarily locked in this position and further insertion is blocked. Further insertion is not enabled until the sleeve is rotated relative to the socket housing 11 and the plug housing 12. Once this has occurred, the second path section can be run through, in which the electrical contact is established. Thereafter, by further rotation of the blocking sleeve, the plug and the socket are locked in coupled state by means of the blocking gate 23 which is effective between the blocking sleeve 22 and the socket housing 11 and between the blocking sleeve and the plug housing 12.

Uncoupling occurs in the opposite direction, in which case, due to the at least twice angled course of the blocking groove 24 and/or 26, a secure intermediate locking of plug and socket with each other occurs so as to form an explosion-proof intermediate space, in which case, in this state, the electrical contacts are already separated.

### REFERENCE SIGNS

10 Connector arrangement
11 Socket housing
12 Plug housing
13-15 Plug contacts
16 Arrow
17-19 Openings
20 Socket contact
21 Cylindrical surface
22 Blocking sleeve
23 Blocking gate
24 Blocking groove
24a First groove section
24u Groove section in circumferential direction
24b Second groove section
25 Cylindrical section of the socket housing 11
26 Blocking groove
27 Annular rib
28 Bearing groove
29 Cam
30 Cam
A—D Detent recesses

1. A connector arrangement comprising:
a plug that comprises a plug housing and at least one electrical plug contact held insulated in the plug housing;
a socket that comprises a socket housing and a socket contact, wherein the socket housing comprises an electrically insulating plug channel for accommodating the plug contacts, in which the socket contact is arranged, and wherein a blocking sleeve is rotatably arranged on the plug housing or the socket housing; and
a blocking gate arrangement that is arranged between the blocking sleeve, the plug housing and the socket housing so as to be effective, said blocking gate arrangement being adapted to clear, during a first position of rotation, a first section of an insertion path of the plug housing and the socket housing, to block however the continued insertion path, as well as, in a second position of rotation, to clear a section of the insertion path of the plug housing and the socket housing.

2. The connector arrangement according to claim 1, wherein the diameter of the plug channel and the diameter of the plug contact are adapted to each other in such a manner that the gap formed between the plug contact and the plug channel prevents a transmission of flame along the insertion channel.

3. The connector arrangement according to claim 1, wherein the length of the first section of the insertion path, as well as the position of the plug contact in the plug channel, are adapted to each other in such a manner that the distance remaining at the end of the first section of the insertion path between the plug contact and the socket contact is greater than the distance required for spark suppression.

4. The connector arrangement according to claim 1, wherein the blocking sleeve is configured as a hollow cylinder and that the cylindrical outside surfaces on the plug housing and on the socket housing are associated with the blocking sleeve.

5. The connector arrangement according to claim 1, wherein, at the latest at the end of the first section of the insertion path, between the blocking sleeve and the socket housing and between the blocking sleeve and the plug housing, there is formed a flame-arresting gap.

6. The connector arrangement according to claim 1, wherein the blocking sleeve displays an angle of rotation delimited by the plug housing or the socket housing.

7. The connector arrangement according to claim 1, wherein the blocking gate arrangement has a blocking groove with a first axial section and with a second axial section, which are at a relative distance from each other by an angle of rotation in circumferential direction and which are connected to each other by a groove section extending in circumferential direction.

8. The connector arrangement according to claim 7, wherein the length of the first axial section corresponds to the length of the first section of the insertion path.

9. The connector arrangement according to claim 7, wherein the length of the second axial section corresponds to the length of the second section of the insertion path.

10. The connector arrangement according to claim 1, wherein the blocking gate arrangement comprises two blocking grooves, which are parallel to each other and are oriented in circumferential direction, and wherein one of said grooves is associated with the plug housing and the other with the socket housing.

11. The connector arrangement according to claim 9, wherein the blocking groove has a circumferential section which is arranged as the locking section at the end of the insertion path.

12. The connector arrangement according to claim 1, wherein the blocking gate arrangement comprises a first cam which is associated with the plug housing and is in engagement with or can be brought into engagement with the blocking groove, and further comprises a second cam which is in engagement with or can be brought in engagement with the blocking groove and is associated with the socket housing.

13. The connector arrangement according to claim 1, wherein, between the plug housing and the blocking sleeve, and/or between the socket housing and the blocking sleeve, there is effectively arranged a detent arrangement.

14. The connector arrangement according to claim 13, wherein the detent arrangement is formed by at least one cam, which is supported in a radially resilient manner, and by at least one associate recess.

15. The connector arrangement according to claim 14, wherein the detent arrangement is part of the blocking groove arrangement.
